(19) United States
(12) Patent Application Publication
(10) Pub. No.: US 2025/0007612 A1
(43) Pub. Date: Jan. 2, 2025

(54) OPTICAL TRANSMISSION DEVICE

(71) Applicant: Fujitsu Limited, Kawasaki-shi (JP)

(72) Inventor: Tomoyuki AKIYAMA, Yokohama (JP)

(73) Assignee: Fujitsu Limited, Kawasaki-shi (JP)

(21) Appl. No.: 18/743,292

(22) Filed: Jun. 14, 2024

(30) Foreign Application Priority Data
Jun. 27, 2023 (JP) 2023-105062

(51) Int. Cl. H04B 10/294; H04B 10/50; H04J 14/02

(52) U.S. Cl. CPC H04B 10/294; H04B 10/506; H04J 14/0221

(57) ABSTRACT

An optical transmission device includes an optical circuit in which circuit groups are connected in multiple stages in a tree form, each of the circuit groups including three circuits of a two-input two-output type each having periodic transmission characteristics, the three circuits being connected in multiple stages in a tree form so that one of subsequent ports of a first circuit at a preceding stage of the three circuits is connected to one of preceding ports of a second circuit at a subsequent stage of the remaining two of the three circuits, and the other of the subsequent ports of the first circuit is connected to one of preceding ports of a third circuit at a subsequent stage of the remaining two, a modulator that is connected to one of subsequent ports of the second circuit, and a 90-degree circuit that is connected to the other of the subsequent ports.

### CROSS-REFERENCE TO RELATED APPLICATION

This application is based upon and claims the benefit of priority of the prior Japanese Patent Application No. 2023-105062, filed on Jun. 27, 2023, the entire contents of which are incorporated herein by reference.

### FIELD

A certain aspect of embodiments described herein relates to an optical transmission device.

### BACKGROUND

Optical demultiplexers used in wavelength division multiplexing optical transmission devices are known as disclosed in, for example, Japanese Patent Application Laid-Open No. 2020-194114. Various types of optical demultiplexers are known. For example, an optical demultiplexer in which asymmetric Mach-Zehnder interferometers (AMZ) having a pair of arms with different lengths are connected in multiple stages in a tree form (hereinafter, referred to as an AMZ-type optical demultiplexer) is known as disclosed in, for example, Japanese Patent Application Laid-Open No. 2019-135524.

### SUMMARY

Signal light beams with respective wavelengths demultiplexed by the AMZ-type optical demultiplexer described above are output from respective AMZs at the last stage, and the output end is randomly determined by the initial optical phase in the pair of arms of each AMZ. That is, it is impossible to uniquely determine which wavelength signal light beam is output from which output end of the AMZ-type optical demultiplexers. This causes a problem that each signal light beam cannot be output from a desired output end. This problem is not limited to the AMZ-type optical demultiplexer described above, and is also present in other optical demultiplexers using an AMZ in which the output end for the signal light beam is randomly determined.

Therefore, it is desirable to provide an optical transmission device that uniquely determines the relationship between the output end and the wavelength of the signal light beam.

According to an aspect of the embodiments, there is provided an optical transmission device including: an optical circuit in which optical unit circuit groups are connected in multiple stages in a tree form, each of the optical unit circuit groups including three optical unit circuits of a two-input two-output type each having periodic transmission characteristics, the three optical unit circuits being connected in multiple stages in a tree form so that a first subsequent-stage port of two subsequent-stage ports of a first optical unit circuit, which is arranged at a preceding-stage as one of the three optical unit circuits, is connected to a first preceding-stage port of two preceding-stage ports of a second optical unit circuit, which is arranged at a subsequent-stage as one of the remaining two of the three optical unit circuits, and a second subsequent-stage port of the two subsequent-stage ports of the first optical unit circuit is connected to a first preceding-stage port of two preceding-stage ports of a third optical unit circuit, which is arranged at a subsequent-stage as the other of the remaining two of the three optical unit circuit; a first light source that outputs a first local oscillator light beam; a second light source that outputs a second local oscillator light beam having a frequency that is half a period away from a period of the second optical unit circuit; an optical modulator including: a predetermined output port that is connected to a first subsequent-stage port of two subsequent-stage ports provided in the second optical unit circuit at a last stage included in a first optical unit circuit group, which is arranged at a last stage of the optical circuit among the three optical unit circuit groups, and a predetermined input port that is connected to the first light source; a 90-degree hybrid circuit including: a first input port connected to a second subsequent-stage port of the two subsequent-stage ports provided in the second optical unit circuit at the last stage, and a second input port connected to the second light source, wherein the optical circuit demultiplexes a first wavelength-multiplexed signal light beam input to a first preceding-stage port of two preceding-stage ports provided in the first optical unit circuit included in a second optical unit circuit group, which is arranged at a first stage of the optical circuit among the three optical unit circuit groups, into first signal light beams with respective first wavelengths different from each other and outputs the first signal light beams from a second subsequent-stage port of the two subsequent-stage ports provided in the second optical unit circuit at the last stage, and multiplexes second signal light beams with respective second wavelengths, which are not adjacent to the first wavelengths, input to a first subsequent-stage port of the two subsequent-stage ports provided in the second optical unit circuit at the last stage, and outputs a second wavelength-multiplexed signal light beam from a second preceding-stage port of the two preceding-stage ports provided in the first optical unit circuit at the first stage.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1A illustrates a part of an optical transmission device in accordance with a comparative example.

FIG. 1B illustrates the remaining part of the optical transmission device in accordance with the comparative example.

FIG. 2 illustrates an optical transmission device in accordance with an embodiment.

### DESCRIPTION OF EMBODIMENTS

Hereinafter, an embodiment for carrying out the present disclosure will be

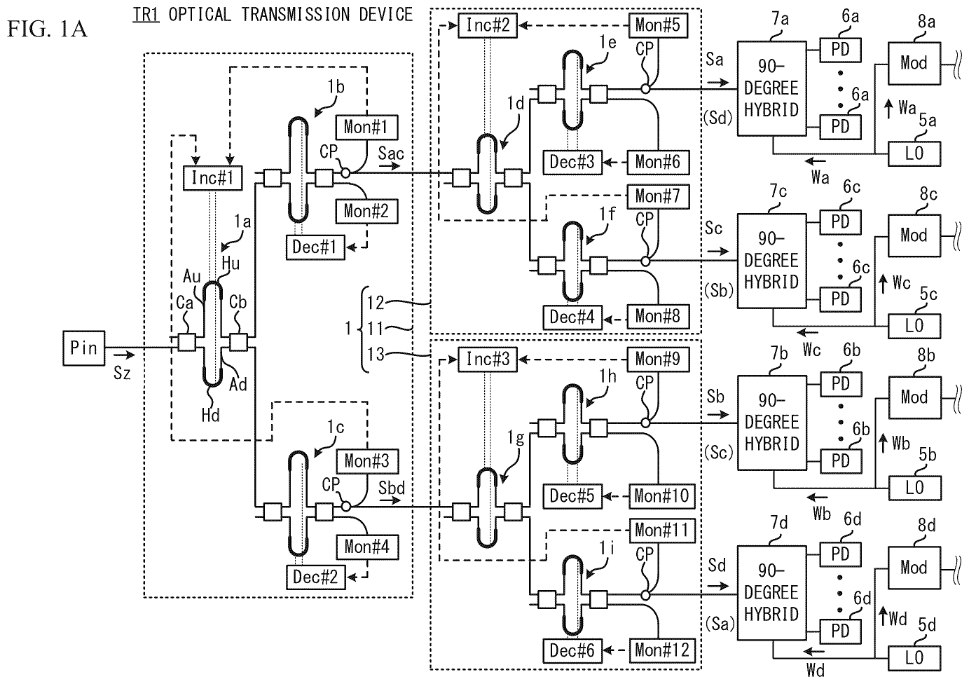

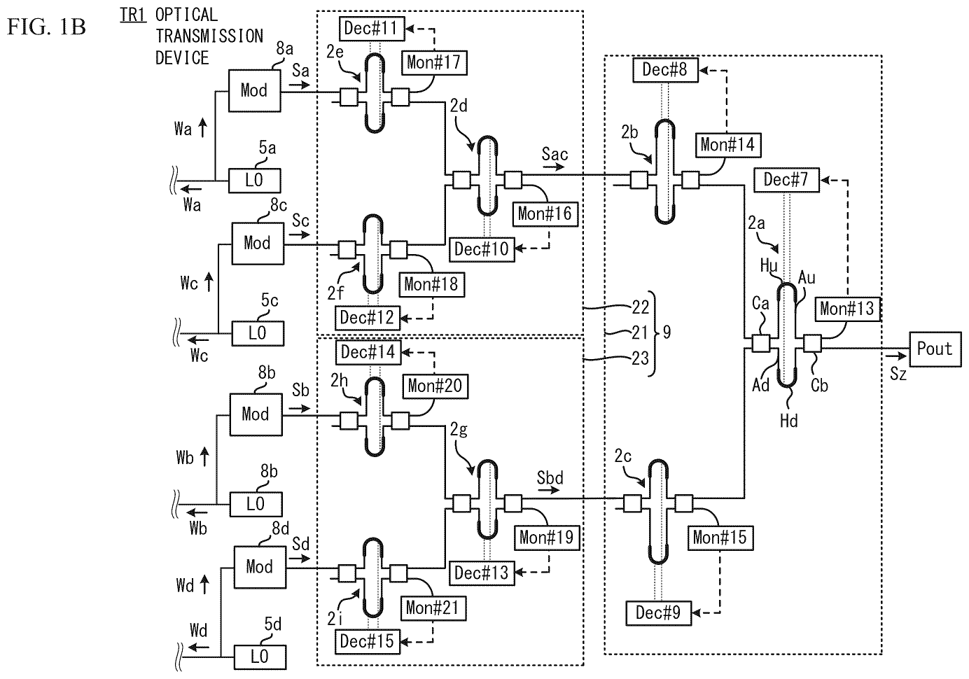

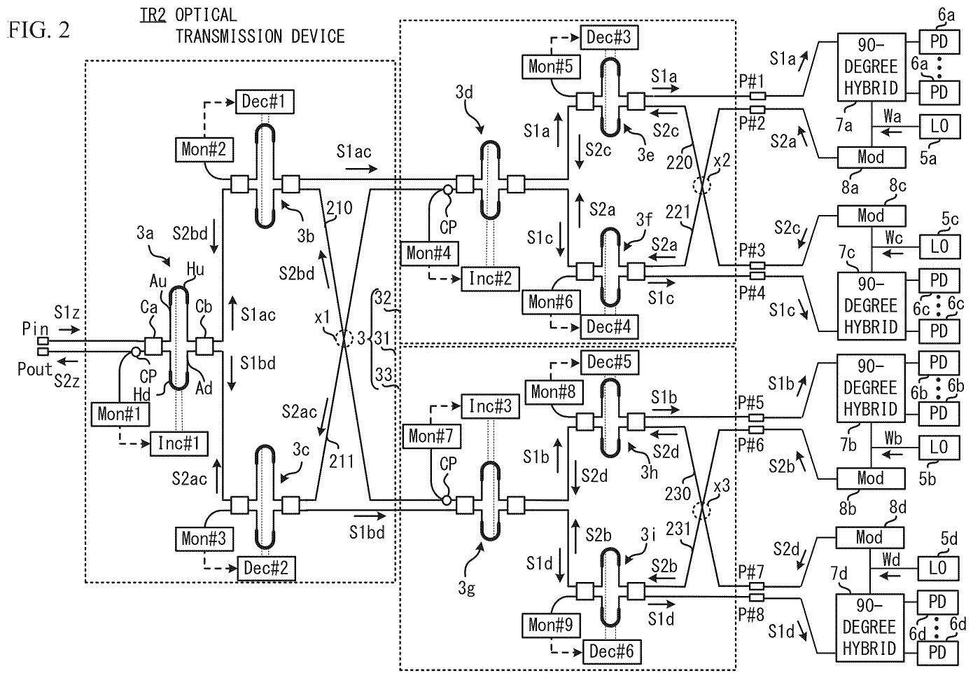

described with reference to the drawings. First, a comparative example will be described with reference to FIG. 1A and FIG. 1B, and then an embodiment will be described with reference to FIG. 2.

### COMPARATIVE EXAMPLE

As illustrated in FIG. 1A, an optical transmission device TR1 in accordance with the comparative example includes an optical demultiplexer 1, photodiodes (PDs) 6a to 6d, and 90-degree hybrid circuits 7a to 7d. As illustrated in FIG. 1B, the optical transmission device TR1 of the comparative example also includes local oscillators (LOs) 5a to 5d, optical modulators (denoted by Mod in FIG. 1B) 8a to 8d, and an optical multiplexer 9. The optical transmission device TR1 includes four PDs 6a, but some of the four PDs 6a are not illustrated in the drawing. The same applies to the PDs 6b to PDs 6d as well as the PDs 6a.

The LO 5a is connected to both the 90-degree hybrid circuit 7a and the optical modulator 8a. The LO 5b is connected to both the 90-degree hybrid circuit 7b and the optical modulator 8b. The LO 5c is connected to both the 90-degree hybrid circuit 7c and the optical modulator 8c. The LO 5d is connected to both the 90-degree hybrid circuit 7d and the optical modulator 8d.

First, the optical demultiplexer 1 will be described in detail with reference to FIG. 1A.

The optical demultiplexer 1 includes a preceding-stage demultiplexing circuit 11 and subsequent-stage demultiplexing circuits 12 and 13 optically connected to stages following the preceding-stage demultiplexing circuit 11, respectively. The optical demultiplexer 1 demultiplexes a wavelength multiplexed signal light beam Sz of four wavelengths λa to λd into signal light beams Sa, Sb, Sc, and Sd with respective center wavelengths λa to λd of regular wavelength spacing, for example. The optical demultiplexer 1 performs demultiplexing processing using each of the preceding-stage demultiplexing circuit 11 and the subsequent-stage demultiplexing circuits 12 and 13 as a unit.

The optical demultiplexer 1 includes AMZs 1a to 1i connected in multiple stages in a tree form (to be specific, a forward tree form). The preceding-stage demultiplexing circuit 11 includes the AMZs 1a to 1c, the subsequent-stage demultiplexing circuit 12 includes the AMZs 1d to 1f, and the subsequent-stage demultiplexing circuit 13 includes the AMZs 1g to 1i. That is, the optical demultiplexer 1 corresponds to an AMZ-type optical demultiplexer. The AMZs 1a to 1i each have a pair of arms Au, Ad with different lengths (waveguide lengths), an input coupler Ca, and an output coupler Cb. Each of the input coupler Ca and the output coupler Cb is a 2×2 coupler having two input ports and two output ports.

The two output ports of the input coupler Ca are optically connected to the input ends of the pair of arms Au and Ad, respectively. The two input ports of the output coupler Cb are optically connected to the output ends of the pair of arms Au and Ad, respectively. The wavelength-multiplexed signal light beam Sz input to the input coupler Ca is input to the pair of arms Au and Ad.

The upper arm Au is provided with a phase shifter Hu, and the lower arm Ad is provided with a phase shifter Hd. The phase shifters Hu and Hd adjust the optical phases in the pair of arms Au and Ad of each of the AMZs 1a to 1i, respectively. This compensates for the shift of the optical phase due to manufacturing variations, and reduces the crosstalk. The phase shifters Hu and Hd are heaters formed of a metal (resistive) thin film such as tungsten, titanium, or platinum, and change the temperatures of the waveguides in the arms Au and Ad, respectively. This changes the refractive indexes in the arms Au and Ad, and thus the optical phases in the arms Au and Ad are adjusted. The phase shifters Hu and Hd are not limited to this configuration, and may be means for electrically changing the respective carrier densities in the waveguides of the arms Au and Ad by the carrier plasma effect.

The optical demultiplexer 1 includes monitor circuits Mon#1 to Mon#12 that monitor the power of the output light beams of the AMZs 1a to 1i, control circuits Dec#1 to Dec#6 that perform control to decrease the power according to the monitoring results of the power of the output light beams, and control circuits Inc#1 to Inc#3 that perform control to increase the power according to the monitoring results of the power of the output light beams, in order to control the phase shifters Hu and Hd of the AMZs 1a to 1i. The monitor circuits Mon#1 to Mon#12 are implemented by, for example, PDs. The control circuits Dec#1 to Dec#3 and Inc#1 to Inc#3 are implemented by hardware circuits such as field programmable gate arrays (FPGAs) or application specified integrated circuits (ASICs).

The monitor circuits Mon#1 to Mon#12 monitor the power of the output light beams of the AMZs 1b, 1c, 1e, 1f, 1h, and 1i. The control circuits Dec#1 to Dec#6 and Inc#1 to Inc#3 control the adjustment amounts of the optical phases in the pair of arms Au and Ad with respect to the phase shifters Hu and Hd according to the power of the output light beams, thereby compensate for the shifts of the optical phases. For example, the control circuits Dec#1 to Dec#6 control the heater power supplied to the phase shifters Hu and Hd so as to lower the temperatures of the phase shifters Hu and Hd. The control circuits Inc#1 to Inc#3 control the heater power supplied to the phase shifters Hu and Hd so as to increase the temperatures of the phase shifters Hu and Hd.

The preceding-stage demultiplexing circuit 11 includes the AMZs 1a to 1c, the control circuits Inc#1, Dec#1, and Dec#2, and the monitor circuits Mon#1 to Mon#4. The AMZs 1b and 1c are optically connected to stages following the AMZ 1a, respectively. The AMZs 1d and 1g are optically connected to the stages following the AMZs 1b and 1c, respectively. An input port Pin from which the wavelength-multiplexed signal light beam Sz is input is provided at the input end of the AMZ 1a.

The monitor circuit Mon#1 is optically connected to a first output port of the output coupler Cb of the AMZ 1b through a branching coupler CP, and the monitor circuit Mon#3 is optically connected to a first output port of the output coupler Cb of the AMZ 1c through the branching coupler CP. The monitor circuit Mon#1 monitors the power of the output light beam output from the AMZ 1b to the AMZ 1d. The monitor circuit Mon#1 notifies the control circuit Inc#1 of the power of the monitoring result. The monitor circuit Mon#3 monitors the power of the output light beam output from the AMZ 1c to the AMZ 1g. The monitor circuit Mon#3 notifies the control circuit Inc#1 of the power of the monitoring result.

The monitor circuit Mon#2 is optically connected to a second output port of the output coupler Cb of the AMZ 1b, and the monitor circuit Mon#4 is optically connected to a second output port of the output coupler Cb of the AMZ 1c. The monitor circuits Mon#2 and Mon#4 monitor the power of the output light beams output from the second output ports of the output couplers Cb, respectively. The monitor circuit Mon#2 notifies the control circuit Dec#1 of the power of the monitoring result. The monitor circuit Mon#4 notifies the control circuit Dec#2 of the power of the monitoring result.

The control circuit Inc#1 controls the adjustment amounts of the optical phases for the phase shifters Hu and Hd of the AMZ 1a in accordance with the monitoring results of the output light beams by the monitor circuits Mon#1 and Mon#3. The control circuit Dec#1 controls the adjustment amounts of the optical phases for the phase shifters Hu and Hd of the AMZ 1b in accordance with the monitoring result of the output light beam by the monitor circuit Mon#2. The control circuit Dec#2 controls the adjustment amounts of the optical phases for the phase shifters Hu and Hd of the AMZ 1c in accordance with the monitoring result of the output light beam by the monitor circuit Mon#4.

With the above configuration, the power of the output light beams output from the first output ports of the output couplers Cb of the AMZs 1b and 1c to the AMZs 1d and 1g at the subsequent stages increases, and the power of the output light beams output from the second output ports of the output couplers Cb of the AMZs 1b and 1c to the monitor circuits Mon#2 and Mon#4 decrease.

The subsequent-stage demultiplexing circuit 12 includes the AMZs 1d to 1f, the control circuits Inc#2, Dec#3, and Dec#4, and the monitor circuits Mon#5 to Mon#8. The AMZs 1e and 1f are optically connected to stages following the AMZ 1d, respectively. First output ports of the output couplers Cb of the AMZs 1e and 1f are connected to the 90-degree hybrid circuits 7a and 7c, respectively, to which the branched light beam is output.

The 90-degree hybrid circuit 7a uses a wavelength light beam Wa with a center frequency λa output from the LO 5a as a local oscillator light beam, and causes the signal light beam Sa and the local oscillator light beam to interfere with each other, thereby detecting an I-channel (inphase component) and a Q-channel (quadrature component) in the X-polarized components. That is, the 90-degree hybrid circuit 7a performs coherent detection in which the signal light beam Sa and the local oscillator light beam are caused to interfere with each other to detect an interfering signal, and the amplitude and phase of the signal light beam Sa are detected. The 90-degree hybrid circuit 7a outputs the photoelectric field component corresponding to the amplitude and phase of the signal light beam Sa to the PDs 6a at the subsequent stage. The PD 6a converts the photoelectric field component into an electrical analog signal. The 90-degree hybrid circuit 7c and the PD 6c are basically the same as the 90-degree hybrid circuit 7a and the PD 6a, respectively, and thus detailed description thereof will be omitted.

The monitor circuit Mon#5 is optically connected to a first output port of the output coupler Cb of the AMZ 1e through the branching coupler CP, and the monitor circuit Mon#7 is optically connected to a first output port of the output coupler Cb of the AMZ 1f through the branching coupler CP. The monitor circuit Mon#5 monitors the power of the output light beam output from the AMZ 1e to the 90-degree hybrid circuit 7a. The monitor circuit Mon#5 notifies the control circuit Inc#2 of the power of the monitoring result. The monitor circuit Mon#7 monitors the power of the output light beam output from the AMZ 1f to the 90-degree hybrid circuit 7c. The monitor circuit Mon#7 notifies the control circuit Inc#2 of the power of the monitoring result.

The monitor circuit Mon#6 is optically connected to a second output port of the output coupler Cb of the AMZ 1e, and the monitor circuit Mon#8 is optically connected to a second output port of the output coupler Cb of the AMZ1 f. The monitor circuit Mon#6 monitors the power of the output light beam output from a second output port of the output coupler Cb of the AMZ 1e, and the monitor circuit Mon#8 monitors the power of the output light beam output from a second output port of the output coupler Cb of the AMZ 1f. The monitor circuit Mon#6 notifies the control circuit Dec#3 of the power of the monitoring result. The monitor circuit Mon#8 notifies the control circuit Dec#4 of the power of the monitoring result.

The control circuit Inc#2 controls the adjustment amounts of the optical phases for the phase shifters Hu and Hd of the AMZ 1d in accordance with the respective monitoring results of the output light beams by the monitor circuits Mon#5 and Mon#7. The control circuit Dec#3 controls the adjustment amounts of the optical phases for the phase shifters Hu and Hd of the AMZ 1e in accordance with the monitoring result of the output light beam by the monitor circuit Mon#6. The control circuit Dec#4 controls the adjustment amounts of the optical phases for the phase shifters Hu and Hd in the AMZ 1f in accordance with the monitoring result of the output light beam by the monitor circuit Mon#8.

With the above configuration, the power of the output light beam output from the first output port of the output coupler Cb of the AMZ 1e to the 90-degree hybrid circuit 7a and the power of the output light beam output from the first output port of the output coupler Cb of the AMZ 1f to the 90-degree hybrid circuit 7c increase, and the power of the output light beam output from the second output port of the output coupler Cb of the AMZ 1e to the monitor circuit Mon#6 and the power of the output light beam output from the second output port of the output coupler Cb of the AMZ 1f to the monitor circuit Mon#8 decrease.

The subsequent-stage demultiplexing circuit 13 includes the AMZs 1g to 1i, the control circuits Inc#3, Dec#5, and Dec#6, and the monitor circuits Mon#9 to Mon#12. The AMZs 1h and the 1i are optically connected to stages following the AMZ 1g, respectively. The 90-degree hybrid circuit 7b, to which the branched light beam is output, is connected to a first output port of the output coupler Cb of the AMZ 1h, and the 90-degree hybrid circuit 7d, to which the branched light beam is output, is connected to a first output port of the output coupler Cb of the AMZ 1i.

The 90-degree hybrid circuit 7b uses a wavelength light beam Wb with a center frequency Ab output from the LO 5b as a local oscillator light beam with a center frequency Ab, and causes the signal light beam Sb and the local oscillator light beam to interfere with each other, thereby detecting an I-channel (inphase components) and a Q-channel (quadrature components) in the X-polarized components. That is, the 90-degree hybrid circuit 7b performs coherent detection in which the signal light beam Sb and the local oscillator light beam are caused to interfere with each other to detect an interfering signal, and the amplitude and phase of the signal light beam Sb are detected. The 90-degree hybrid circuit 7b outputs the photoelectric field component corresponding to the amplitude and phase of the signal light beam Sb to the PDs 6b at the subsequent stage. The PD 6b converts the photoelectric field component into an electrical analog signal. The 90-degree hybrid circuit 7d and the PD 6d are basically the same as the 90-degree hybrid circuit 7b and the PD 6b, respectively, and thus detailed description thereof will be omitted.

The monitor circuit Mon#9 is optically connected to a first output port of the output coupler Cb of the AMZ 1h through the branching coupler CP, and the monitor circuit Mon#11 is optically connected to a first output port of the output coupler Cb of the AMZ li through the branching coupler CP. The monitor circuit Mon#9 monitors the power of the output light beam output from the AMZ 1h to the 90-degree hybrid circuit 7b. The monitor circuit Mon#9 notifies the control circuit Inc#3 of the power of the monitoring result. The monitor circuit Mon#12 monitors the power of the output light beam output from the AMZ 1i to the 90-degree hybrid circuit 7d. The monitor circuit Mon#11 notifies the control circuit Inc#3 of the power of the monitoring result. The monitor circuit Mon#10 is optically connected to a second output port of

the output coupler Cb of the AMZ 1h, and the monitor circuit Mon#12 is optically connected to a second output port of the output coupler Cb of the AMZ 1i. The monitor circuit Mon#10 monitors the power of the output light beam output from a second output port of the output coupler Cb, and the monitor circuit Mon#12 monitors the power of the output light beam output from a second output port of the output coupler Cb. The monitor circuit Mon#10 notifies the control circuit Dec#5 of the power of the monitoring result. The monitor circuit Mon#12 notifies the control circuit Dec#6 of the power of the monitoring result.

The control circuit Inc#3 controls the adjustment amounts of the optical phases for the phase shifters Hu and Hd in the AMZ 1g in accordance with the respective monitoring results of the output light beams by the monitor circuits Mon#9 and Mon#11. The control circuit Dec#5 controls the adjustment amounts of the optical phases for the phase shifters Hu and Hd of the AMZ 1h in accordance with the monitoring result of the output light beam by the monitor circuit Mon#10. The control circuit Dec#6 controls the adjustment amounts of the optical phases for the phase shifters Hu and Hd in the AMZ li in accordance with the monitoring result of the output light beam by the monitor circuit Mon#12.

With the above configuration, the power of the output light beam output from the first output port of the output coupler Cb of the AMZ 1h to the 90-degree hybrid circuit 7b and the power of the output light beam output from the first output port of the output coupler Cb of the AMZ 1i to the 90-degree hybrid circuit 7d increase, and the power of the output light beam output from the second output port of the output coupler Cb of the AMZ 1h to the monitor circuit Mon#10 and the power of the output light beam output from the second output port of the output coupler Cb of the AMZ 1i to the monitor circuit Mon#12 decrease.

As described above, the preceding-stage demultiplexing circuit 11 and the

subsequent-stage demultiplexing circuits 12 and 13 are connected in multiple stages in a tree form so that the wavelength-multiplexed signal light beam Sz of center wavelengths λa to λd are input from the AMZ 1a to each of the AMZs 1b and 1c, and are input from the AMZs 1b and 1c to the separate AMZs 1d and 1g at the subsequent stages, respectively. The wavelength intervals of the transmission bands of the AMZs 1a to 1i are determined according to their arm length differences. More specifically, the wavelength intervals of the transmission bands of the AMZ 1a to 1i are substantially inversely proportional to their arm length differences.

The arm length difference of each of the AMZ 1a to 1c is set so that the wavelength interval of the transmission band is equal to the wavelength spacing 42 of the center wavelengths λa to λd. The arm length differences of the AMZs 1d to 1f and the AMZ 1g to 1i are set to 1/2 times the arm length differences of the AMZ 1a to 1c so that the wavelength interval of the transmission band is two times (2×Δλ) the spacing Δλ of the center wavelengths.

Thus, the preceding-stage demultiplexing circuit 11 demultiplexes the wavelength-multiplexed signal light beam Sz into the wavelength-multiplexed signal light beam Sac of center wavelengths λa and λc and the wavelength-multiplexed signal light beam Sbd of center wavelengths λb and λd. The subsequent-stage demultiplexing circuit 12 demultiplexes the wavelength-multiplexed signal light beam Sac into the signal light beam Sa with a center wavelengths λa and the signal light beam Sc with a center wavelength λc. The subsequent-stage demultiplexing circuit 13 demultiplexes the wavelength-multiplexed signal light beam Sbd into the signal light beam Sb with a center wavelength λb and the signal light beam Sd with a center wavelength λd.

In this case, the output destinations of the signal light beams Sa to Sd with respective center wavelengths λa to λd are randomly determined by the initial optical phases in the pair of arms Au and Ad of each of the AMZ 1a to 1i. Therefore, the signal light beam Sa with a center wavelength λa may be output from the AMZ 1e, or the signal light beam Sd with a center wavelength λd may be output from the AMZ 1e as indicated in the parentheses. Similarly, the signal light beam Sc with a center wavelength λc may be output from the AMZ 1f, or the signal light beam Sb with a center wavelength λb may be output from the AMZ 1f. The signal light beam Sb may be output from the AMZ 1h, or the signal light beam Sc may be output from the AMZ 1h. The signal light beam Sd may be output from the AMZ 1i, or the signal light beam Sa may be output from the AMZ 1i. As described above, combinations of the signal light beams Sa, Sb, Sc, and Sd with respective center wavelengths λa to λd and the output ends of the AMZs 1e, 1f, 1h, and 1i are not always the same.

As described above, the optical transmission device TS1 according to the comparative example has a problem that the signal light beams Sa, Sb, Sc, and Sd cannot be output to a desired output destination, and it is difficult to perform appropriate signal processing for each of the signal light beams Sa, Sb, Sc, and Sd.

Next, the optical multiplexer 9 will be described in detail with reference to FIG. 1B.

The optical multiplexer 9 includes preceding-stage multiplexing circuits 22 and 23 and a subsequent-stage multiplexing circuit 21 optically connected to a stage following the preceding-stage multiplexing circuits 22 and 23. The optical multiplexer 9 multiplexes the signal light beams Sa, Sb, Sc, and Sd with respective center wavelengths λa to λd of regular wavelength spacing into the wavelength-multiplexed signal light beam Sz of four wavelengths λa to λd, for example. The optical multiplexer 9 performs multiplexing processing using each of the preceding-stage multiplexing circuits 22 and 23 and the subsequent-stage multiplexing circuit 21 as a unit.

The optical multiplexer 9 includes AMZs 2a to 2i connected in multiple stages in a tree form (in particular, an inverted tree form). The preceding-stage multiplexing circuit 22 includes the AMZs 2d to 2f, the preceding-stage multiplexing circuit 23 includes the AMZs 2g to 2i, and the subsequent-stage multiplexing circuit 21 includes the AMZs 2a to 2c. That is, the optical multiplexer 9 may be referred to as an AMZ-type optical multiplexer. Each of the AMZs 2a to 2i includes a pair of arms Au and Ad with different lengths (waveguide lengths), an input coupler Ca, and an output coupler Cb. Each of the input coupler Ca and the output coupler Cb is a 2×2 coupler having two input ports and two output ports.

The two output ports of the input coupler Ca are optically connected to the input ends of the pair of arms Au and Ad, respectively. The two input ports of the output coupler Cb are optically connected to the output ends of the pair of arms Au and Ad, respectively. The wavelength-multiplexed signal light beam Sz output from the output coupler Cb is input to the output port Pout.

The upper arm Au is provided with a phase shifter Hu, and the lower arm Ad is provided with a phase shifter Hd. The phase shifters Hu and Hd adjust the optical phases in the pair of arms Au and Ad of the AMZs 2a to 2i, respectively. This compensates for optical phase shift due to manufacturing variations and reduces crosstalk.

The optical multiplexer 9 includes monitor circuits Mon#13 to Mon#21 that monitor the power of the output light beams of the AMZs 2a to 2i and control circuits Dec#7 to Dec#15 that perform control to decrease the power in accordance with the monitoring results of the power of the output light beams in order to control the phase shifters Hu and Hd of the AMZs 2a to 2i, respectively. The monitor circuits Mon#13 to Mon#21 are implemented by, for example, PDs. The control circuits Dec#7 to Dec#15 are implemented by hardware circuits such as FPGAs or ASICs.

The monitor circuits Mon#13 to Mon#21 monitor the power of the output light beams of the AMZ 2a to 2i, respectively. The control circuits Dec#7 to Dec#15 compensate for the optical phase shifts by controlling the adjustment amounts of the optical phases in the pair of arms Au and Ad with respect to the phase shifters Hu and Hd according to the power of the output light beams. For example, the control circuits Dec#7 to Dec#15 control the heater power supplied to the phase shifters Hu and Hd so as to decrease the temperatures of the phase shifters Hu and Hd.

The preceding-stage multiplexing circuit 22 includes the AMZs 2d to 2f, the control circuits Dec#10 to Dec#12, and the monitor circuits Mon#16 to Mon#18. The AMZ 2d is optically connected to the stage following the AMZs 2e and 2f. The AMZ 2b is optically connected to the stage following the AMZ 2d. The input end of the AMZ 2e is connected to the optical modulator 8a from which the signal light beam Sa is output. The input end of the AMZ 2f is connected to the optical modulator 8c from which the signal light beam Sc is output.

The optical modulator 8a uses the wavelength light beam Wa with a center wavelength λa output from the LO 5a as a transmission light beam with a center wavelength λa and optically modulates the transmission light beam based on the signal-processed electrical signal. The optically modulated transmission light beam with a center wavelength λa is input to the AMZ 2e of the optical multiplexer 9 as the signal light beam Sa. The optical modulator 8c uses the wavelength light beam Wc with a center wavelength λc output from the LO 5c as a transmission light beam with a center wavelength λc and optically modulates the transmission light beam based on the signal-processed electrical signal. The optically modulated transmission light beam with a center wavelength λc is input to the AMZ 2f of the optical multiplexer 9 as the signal light beam Sc.

The monitor circuit Mon#17 is optically connected to a first output port of the output coupler Cb of the AMZ 2e, and the monitor circuit Mon#18 is optically connected to a first output port of the output coupler Cb of the AMZ 2f. The monitor circuit Mon#17 monitors the power of the output light beam output from the first output port of the output coupler Cb of the AMZ 2e, and the monitor circuit Mon#18 monitors the power of the output light beam output from the first output port of the output coupler Cb of the AMZ 2f. The monitor circuit Mon#17 notifies the control circuit Dec#11 of the power of the monitoring result. The monitor circuit Mon#18 notifies the control circuit Dec#12 of the power of the monitoring result.

The control circuit Dec#11 controls the adjustment amounts of the optical phases for the phase shifters Hu and Hd of the AMZ 2e in accordance with the monitoring result of the output light beam by the monitor circuit Mon#17. The control circuit Dec#12 controls the adjustment amounts of the optical phases for the phase shifters Hu and Hd of the AMZ 2f in accordance with the monitoring result of the output light beam by the monitor circuit Mon#18.

With the above configuration, the power of the output light beam output from

a second output port of the output coupler Cb of the AMZ 2e to the AMZ 2d at the subsequent stage and the power of the output light beam output from a second output port of the output coupler Cb of the AMZ 2f to the AMZ 2d at the subsequent stage remain the same, and the power of the output light beam output from the first output port of the output coupler Cb of the AMZ 2e to the monitor circuit Mon#17 and the power of the output light beam output from the first output port of the output coupler Cb of the AMZ 2f to the monitor circuit Mon#18 decrease.

The preceding-stage multiplexing circuit 23 includes the AMZs 2g to 2i, the control circuits Dec#13 to Dec#15, and the monitor circuits Mon#19 to Mon#21. The AMZ 2g is optically connected to the stage following the AMZs 2h and 2i. The AMZ 2c is optically connected to the stage following the AMZ 2g. The input end of the AMZ 2h is connected to the optical modulator 8b from which the signal light beam Sb is output. The input end of the AMZ 2i is connected to the optical modulator 8d from which the signal light beam Sd is output.

The optical modulator 8b uses the wavelength light beam Wb with a center wavelength λb output from the LO 5b as a transmission light beam with a center wavelength λb and optically modulates the transmission light beam based on the signal-processed electrical signal. The optically modulated transmission light beam with a center wavelength λb is input to the AMZ 2h of the optical multiplexer 9 as the signal light beam Sb. The optical modulator 8d uses the wavelength light beam Wd with a center wavelength λd output from the LO 5d as a transmission light beam with a center wavelength λd and optically modulates the transmission light beam based on the signal-processed electrical signal. The optically modulated transmission light with a center wavelength λd is input to the AMZ 2i of the optical multiplexer 9 as the signal light beam Sd.

The monitor circuit Mon#20 is optically connected to a first output port of the

output coupler Cb of the AMZ 2h, and the monitor circuit Mon#21 is optically connected to a first output port of the output coupler Cb of the AMZ 2i. The monitor circuit Mon#20 monitors the power of the output light beam output from the first output port of the output coupler Cb of the AMZ 2h, and the monitor circuit Mon#21 monitors the power of the output light beam output from the first output port of the output coupler Cb of the AMZ 2i. The monitor circuit Mon#20 notifies the control circuit Dec#14 of the power of the monitoring result. The monitor circuit Mon#21 notifies the control circuit Dec#15 of the power of the monitoring result.

The control circuit Dec#14 controls the adjustment amounts of the optical phases for the phase shifters Hu and Hd of the AMZ 2h in accordance with the monitoring result of the output light beam by the monitor circuit Mon#20. The control circuit Dec#15 controls the adjustment amounts of the optical phases for the phase shifters Hu and Hd of the AMZ 2i in accordance with the monitoring result of the output light beam by the monitor circuit Mon#21.

With the above configuration, the power of the output light beam output from

a second output port of the output coupler Cb of the AMZ 2h to the AMZ 2g at the subsequent stage and the power of the output light beam output from a second output port of the output coupler Cb of the AMZ 2i to the AMZ 2g at the subsequent stage remain the same, and the power of the output light beam output from the first output port of the output coupler Cb of the AMZ 2h to the monitor circuit Mon#20 and the power of the output light beam output from the first output port of the output coupler Cb of the AMZ 2i to the monitor circuit Mon#21 decrease.

The subsequent-stage multiplexing circuit 21 includes the AMZ 2a to 2c, the control circuits Dec#7 to Dec#9, and the monitor circuits Mon#13 to Mon#15. The AMZ 2a is optically connected to the stage following the AMZs 2b and 2c. An output port Pout, to which the wavelength-multiplexed signal light beam Sz is output, is provided at the output end of the AMZ 2a.

The monitor circuit Mon#14 is optically connected to a first output port of the output coupler Cb of the AMZ 2b, and the monitor circuit Mon#15 is optically connected to a first output port of the output coupler Cb of the AMZ 2c. The monitor circuit Mon#14 monitors the power of the output light beam output from the first output port of the output coupler Cb of the AMZ 2b, and the monitor circuit Mon#15 monitors the power of the output light beam output from the first output port of the output coupler Cb of the AMZ 2c. The monitor circuit Mon#14 notifies the control circuit Dec#8 of the power of the monitoring result. The monitor circuit Mon#15 notifies the control circuit Dec#9 of the power of the monitoring result.

The control circuit Dec#8 controls the adjustment amounts of the optical phases for the phase shifters Hu and Hd of the AMZ 2b in accordance with the monitoring result of the output light beam by the monitor circuit Mon#14. The control circuit Dec#9 controls the adjustment amounts of the optical phases for the phase shifters Hu and Hd of the AMZ 2c in accordance with the monitoring result of the output light beam by the monitor circuit Mon#15.

With the above configuration, the power of the output light beam output from a second output port of the output coupler Cb of the AMZ 2b to the AMZ 2a at the subsequent stage and the power of the output light beam output from a second output port of the output coupler Cb of the AMZ 2c to the AMZ 2a at the subsequent stage remain the same, and the power of the output light beam output from the first output port of the output coupler Cb of the AMZ 2b to the monitor circuit Mon#14 and the power of the output light beam output from the first output port of the output coupler Cb of the AMZ 2c to the monitor circuit Mon#15 decrease.

As described above, the preceding-stage multiplexing circuits 22 and 23 and the subsequent-stage multiplexing circuit 21 are connected in multiple stages in a tree form so that the signal light beam Sa with a center wavelength λa to the signal light beam Sd with a center wavelength Ad are input from the AMZs 2e, 2f, 2h, and 2i to the AMZs 2d and 2g, respectively, and are input from the AMZs 2d and 2g to the different AMZs 2b and 2c at the subsequent stage, respectively. The wavelength interval of the transmission band of each of the AMZs 2a to 2i is determined according to its arm length difference. More specifically, the wavelength interval of the transmission band of each of the AMZs 2a to 2i is substantially inversely proportional to its arm length difference.

The arm length difference of each of the AMZs 2a to 2c is set so that the wavelength interval of the transmission band is equal to the wavelength spacing Δλ of the center wavelengths λa to λd. The arm length difference of each of the AMZs 2d to 2f and the AMZs 2g to 2i is set to ½ times the arm length difference of each of the AMZs 2a to 2c so that the wavelength interval of the transmission band is two times (2×Δλ) the spacing Δλ of the center wavelengths.

Thus, the preceding-stage multiplexing circuit 22 multiplexes the signal light beam Sa with a center wavelength λa and the signal light beam Sc with a center wavelength λc into the wavelength-multiplexed signal light beam Sac of center wavelengths λa and λc. The preceding-stage multiplexing circuit 23 multiplexes the signal light beam Sb with a center wavelength λb and the signal light beam Sd with a center wavelength λd into the wavelength-multiplexed signal light beam Sbd of center wavelengths λb and λd. The subsequent-stage multiplexing circuit 21 multiplexes the wavelength-multiplexed signal light beam Sac and the wavelength-multiplexed signal light beam Sbd into the wavelength-multiplexed signal light beam Sz.

As described above, in the optical transmission device TS1 according to the comparative example, the optical demultiplexer 1 includes nine phase shifters Hu and nine phase shifters Hd. In the optical transmission device TS1 according to the comparative example, the optical multiplexer 9 includes nine phase shifters Hu and nine phase shifters Hd. That is, the total number of the phase shifters Hu and Hd is 36. This leads to problems such as an increase in the size of the optical transmission device TS1 and high power consumption.

### EMBODIMENT

An optical transmission device TR2 in accordance with an embodiment will be described with reference to FIG. 2. The same components as those of the respective devices of the optical transmission device TR1 illustrated in FIG. 1A and FIG. 1B are basically denoted by the same symbols or the corresponding symbols, and the description thereof will be omitted.

As illustrated in FIG. 2, the optical transmission device TR2 according to the embodiment includes an optical circuit 3, the LOs 5a to 5d, the PDs 6a to 6d, the 90-degree hybrid circuits 7a to 7d, and the optical modulators 8a to 8d. The optical transmission device TR2 includes four PDs 6a, but some of the four PDs 6a are not illustrated.

The LO 5a is connected to both the 90-degree hybrid circuit 7a and the optical modulator 8a. The LO 5b is connected to both the 90-degree hybrid circuit 7b and the optical modulator 8b. The LO 5c is connected to both the 90-degree hybrid circuit 7c and the optical modulator 8c. The LO 5d is connected to both the 90-degree hybrid circuit 7d and the optical modulator 8d. The LO 5c is an example of a first light source. The LO 5a is an example of a second light source. The LO 5a outputs a local oscillator light beam whose frequency is shifted by a half period from the period of an AMZ 3e described later, for example.

The wavelength light beams Wa to Wd output from the LOs 5a to 5d are input to the input ports of the optical modulators 8a to 8d, respectively, as transmission light beams. The input port of the optical modulator 8c is an example of a predetermined input port. The output port of the optical modulator 8c is an example of a predetermined optical port. Wavelength light beams whose frequencies are shifted by a half period from those of the wavelength light beams Wa to Wd output from the LOs 5a to 5d are input to first input ports of the two input ports of the 90-degree hybrid circuits 7a to 7d, respectively, as local oscillator light beams. The input port of the 90-degree hybrid circuit 7a to which the wavelength light beam Wa output from the LO 5a is input is an example of a second input port. The input port of the 90-degree hybrid circuit 7a to which a signal light beam S1a output from the AMZ 3e is input is an example of a first input port.

The optical circuit 3 includes a preceding-stage optical unit circuit group 31 and subsequent-stage optical unit circuit groups 32 and 33 that are optically connected to stages following the preceding-stage optical unit circuit group 31. The optical circuit 3 demultiplexes a wavelength-multiplexed signal light beam S1z of four wavelengths λa to λd into signal light beams S1a, S1b, S1c, and S1d with respective center wavelengths λa to λd of regular wavelength spacing, for example. The optical circuit 3 multiplexes signal light beams S2a, S2b, S2c, and S2d with respective center wavelengths λa to λd of regular wavelength spacing into a wavelength-multiplexed signal light beam S2z of wavelengths λa to λd, for example. The optical circuit 3 performs demultiplexing processing and multiplexing processing using each of the preceding-stage optical unit circuit group 31 and the subsequent-stage optical unit circuit groups 32 and 33 as a unit.

The optical circuit 3 includes AMZs 3a to 3i connected in multiple stages in a tree form (in particular, a forward tree form). That is, the optical circuit 3 may be referred to as an AMZ-type optical circuit. The preceding-stage optical unit circuit group 31 includes the AMZs 3a to 3c as three unit circuits. The subsequent-stage optical unit circuit group 32 includes the AMZs 3d to 3f as three unit circuits. The subsequent-stage optical unit circuit group 33 includes the AMZs 3g to 3i as three unit circuits. For example, the AMZ 3a is an example of a first optical unit circuit. The AMZ 3b is an example of a second optical unit circuit. The AMZ 3c is an example of a third optical unit circuit. The AMZs 3a to 3i each have periodic transmission characteristics, and the periods of the AMZ 3a to 3i are the same. The AMZs 3a to 3i each have a pair of arms Au and Ad with different lengths (waveguide lengths), an input coupler Ca, and an output coupler Cb. Each of the input coupler Ca and the output coupler Cb is a 2×2 coupler having two preceding-stage ports and two subsequent-stage ports. Therefore, each of the AMZ 3a to 3i may be referred to as a two-input two-output type optical unit circuit. For example, a first subsequent-stage port of the two subsequent-stage ports of the AMZ 3a is optically connected to a first preceding-stage port of the two preceding-stage ports of the AMZ 3b, and a second subsequent-stage port of the two subsequent-stage ports of the AMZ 3a is optically connected to a first preceding-stage port of the two preceding-stage ports of the AMZ 3c.

The relationship between a first preceding-stage port of the two preceding-stage ports of the input coupler Ca and a first subsequent-stage port of the two subsequent-stage ports of the output coupler Cb and the relationship between a second preceding-stage port of the two preceding-stage ports of the input coupler Ca and a second subsequent-stage port of the two subsequent-stage ports of the output coupler Cb have equivalent transmission spectra. The relationship between the first preceding-stage port of the two preceding-stage ports of the input coupler Ca and the second subsequent-stage port of the two subsequent-stage ports of the output coupler Cb and the relationship between the second preceding-stage port of the two preceding-stage ports of the input coupler Ca and the first subsequent-stage port of the two subsequent-stage ports of the output coupler Cb also have equivalent transmission spectra. On the other hand, the relationship between the first preceding-stage port of the two preceding-stage ports of the input coupler Ca and the first subsequent-stage port of the two subsequent-stage ports of the output coupler Cb and the relationship between the first preceding-stage port of the two preceding-stage ports of the input coupler Ca and the second subsequent-stage port of the two subsequent-stage ports of the output coupler Cb have transmission spectra in a complementary or reciprocal (hereinafter, simply referred to as complementary) relationship such as t:1−t (t is a real number or a natural number). The relationship between the second preceding-stage port of the two preceding-stage ports of the input coupler Ca and the first subsequent-stage port of the two subsequent-stage ports of the output coupler Cb and the relationship between the second preceding-stage port of the two preceding-stage ports of the input coupler Ca and the second subsequent-stage port of the two subsequent-stage ports of the output coupler Cb also have transmission spectra in a complementary relationship such as t:1−t. For example, the center wavelength λa and the center wavelength λc have a complementary relationship, and the center wavelength λb and the center wavelength λd have a complementary relationship. Thus, the complementary relationship corresponds to a relationship in which the center wavelength is inverted by a half period.

The wavelength-multiplexed signal light beam S1z input to the input coupler Ca is input to the pair of arms Au and Ad. The phase shifters Hu and Hd adjust the optical phases in the pair of arms Au and Ad of the AMZs 3a to 3i, respectively. This compensates for optical phase shift due to manufacturing variations and reduces crosstalk between input and output. The first optical unit circuit can be implemented by the AMZ 3a and the phase shifters Hu and Hd of the AMZ 3a. The second optical unit circuit can be implemented by the AMZ 3b and the phase shifters Hu and Hd of the AMZ 3b. The third optical unit circuit can be implemented by the AMZ 3c and the phase shifters Hu and Hd of the AMZ 3c. Also for the AMZ 3d to 3i, the first optical unit circuit, the second optical unit circuit, and the third optical unit circuit can be implemented by the same relationship as the AMZ 3a to 3c, respectively. The first optical unit circuit, the second optical unit circuit, and the third optical unit circuit all have periodic transmission characteristics.

The optical circuit 3 includes the monitor circuits Mon#1 to Mon#9 that monitor the power of the output light beams of the AMZs 3a to 3i, the control circuits Dec#1 to Dec#6 that decrease the power according to the monitoring results of the power of the output light beams, and the control circuits Inc#1 to Inc#3 that increase the power according to the monitoring results of the power of the output light beams, in order to control the phase shifters Hu and Hd of the AMZs 3a to 3i. The control circuits Dec#1 to Dec#6 are examples of a first control circuit, and the control circuits Inc#1 to Inc#3 are examples of a second control circuit.

The monitor circuits Mon#1 to Mon#9 monitor the power of the output light beams of the AMZ 3a to 3i, respectively. The control circuits Dec#1 to Dec#6 and Inc#1 to Inc#3 control the adjustment amounts of the optical phases in the pair of arms Au and Ad with respect to the phase shifters Hu and Hd according to the power of the output light beams, thereby compensate for the optical phase shift. For example, the control circuits Dec#1 to Dec#6 control the heater power supplied to the phase shifters Hu and Hd so as to lower the temperatures of the phase shifters Hu and Hd. The control circuits Inc#1 to Inc#3 control the heater power supplied to the phase shifters Hu and Hd so as to increase the temperatures of the phase shifters Hu and Hd.

The preceding-stage optical unit circuit group 31 includes the AMZs 3a to 3c, the control circuits Inc#1, Dec#1, and Dec#2, and the monitor circuits Mon#1 to Mon#3. The AMZs 3b and 3c are optically connected to stages following the AMZ 3a, respectively. The AMZs 3d and 3g are optically connected to stages following the AMZ 3b, respectively. The AMZs 3d and 3g are optically connected to stages following the AMZ 3c, respectively. The input port Pin from which the wavelength-multiplexed signal light beam S1z is input is provided at the input end of the AMZ 3a. The output port Pout to which the wavelength-multiplexed signal light beam S2z is output is provided at the output end of the AMZ 3a.

The AMZs 3e and 3f are optically connected to stages following the AMZ 3d, respectively. The 90-degree hybrid circuit 7a is optically connected to the stage following the AMZ 3e through an output port P#1, and the optical modulator 8a is optically connected to the stage following the AMZ 3f through an output port P#2. The optical modulator 8c is optically connected to the stage following the AMZ 3e through an output port P#3, and the 90-degree hybrid circuit 7c is optically connected to the stage following the AMZ 3f through an output port P#4.

The AMZs 3h and 3i are optically connected to the stage following the AMZ 3g. The 90-degree hybrid circuit 7b is optically connected to the stage following the AMZ 3h through an output port P#5, and the optical modulator 8b is optically connected to the stage following the AMZ 3i through an output port P#6. The optical modulator 8d is optically connected to the stage following the AMZ 3h through an output port P#7, and the 90-degree hybrid circuit 7d is optically connected to the stage following the AMZ 3i through an output port P#8.

The wavelength interval of the transmission band of each of the AMZs 3a to 3i is determined according to its arm length difference. More specifically, the wavelength interval of the transmission band of each of the AMZ 3a to 3i is substantially inversely proportional to its arm length difference.

The arm length difference of each of the AMZs 3a to 3c of the preceding-stage optical unit circuit group 31 is set so that the wavelength interval of the transmission band is equal to the spacing Δλ of the center wavelengths λa to λd. Therefore, the preceding-stage optical unit circuit group 31 transmits and demultiplexes the wavelength-multiplexed signal light beam S1z in the transmission band of the interval Δλ. The preceding-stage optical unit circuit group 31 transmits and multiplexes wavelength-multiplexed signal light beams S2bd and S2ac in the transmission band of the interval Δλ.

The arm length differences of the AMZs 3d to 3i are set so that the wavelength intervals of the transmission bands are two times (2×Δλ) the spacing Δλ of the center wavelengths. Therefore, the subsequent-stage optical unit circuit group 32 transmits and demultiplexes a wavelength-multiplexed signal light beam S1ac in the transmission band of the interval Δλ. The subsequent-stage optical unit circuit group 32 transmits and multiplexes the signal light beams S2a and S2c in the transmission band of the interval Δλ. The subsequent-stage optical unit circuit group 33 transmits and demultiplexes a wavelength-multiplexed signal light beam S1bd in the transmission band of the interval Δλ. The subsequent-stage optical unit circuit group 33 transmits and multiplexes the signal light beams S2b and S2d in the transmission band of the interval Δλ.

A waveguide 210 extending from a first subsequent-stage port of the two subsequent-stage ports provided in the output coupler Cb of the AMZ 3b and a waveguide 211 extending from a first subsequent-stage port of the two subsequent-stage ports provided in the output coupler Cb of the AMZ 3c intersect at a crossover point x1 and are connected to a first preceding-stage port of the two preceding-stage ports provided in the input coupler Ca of the AMZ 3g at the subsequent stage and a first preceding-stage port of the two preceding-stage ports provided in the input coupler Ca of the AMZ 3d at the subsequent stage, respectively. A waveguide 220 extending from a first subsequent-stage port of the two subsequent-stage ports provided in the output coupler Cb of the AMZ 3e and a waveguide 221 extending from a first subsequent-stage port of the two subsequent-stage ports provided in the output coupler Cb of the AMZ 3f intersect at a crossover point x2 and are connected to the optical modulators 8c and 8a at the subsequent-stage through the output ports P#3 and P#2, respectively. A waveguide 230 extending from a first subsequent-stage port of the two subsequent-stage ports provided in the output coupler Cb of the AMZ 3h and a waveguide 231 extending from a first subsequent-stage port of the two subsequent-stage ports provided in the output coupler Cb of the AMZ 3i intersect at a crossover point x3 and are connected to the optical modulators 8d and 8b at the subsequent stages through the output ports P#7 and P#6, respectively.

As described above, in the subsequent-stage optical unit circuit group 32, the waveguides are configured to intersect at the crossover point x2. Therefore, the signal light beam S2c with a center wavelength λc output from the optical modulator 8c is input to the AMZ 3e, and the signal light beam S2a with a center wavelength λa output from the optical modulator 8a is input to the AMZ 3f. In the subsequent-stage optical unit circuit group 33, the waveguides are configured to intersect at the crossover point x3. Therefore, the signal light beam S2d with a center wavelength λd output from the optical modulator 8d is input to the AMZ 3h, and the signal light beam S2b with a center wavelength λb output from the optical modulator 8b is input to the AMZ 3i. Further, in the preceding-stage optical unit circuit group 31, the waveguides are configured to intersect at the crossover point x1. Therefore, the wavelength-multiplexed signal light beam S2bd of center wavelengths λb and λd output from the AMZ 3g is input to the AMZ 3b, and the wavelength-multiplexed signal light beam S2ac of center wavelengths λa and λc output from the AMZ 3d is input to the AMZ 3c.

In the optical transmission device TR2, the total number of the phase shifters Hu and Hd is 18, compared to the optical transmission device TR1 using 36 phase shifters Hu and Hd. Thus, the optical transmission device TR2 can be smaller in size than the optical transmission device TR1. Further, since the total number of the phase shifters Hu and Hd is smaller than that of the optical transmission device TR1, the power required for controlling the phase shifters Hu and Hd can be reduced, and the power consumption is reduced.

In the optical transmission device TR2, for example, the signal light beam S1a output from the AMZ 3d is guided to the AMZ 3e, while the signal light beam S2c output from the AMZ 3e is guided to the AMZ 3d. Due to the crossover point x2, the signal light beams S2c and S1a with different wavelengths are transmitted in the waveguide connecting the AMZ 3d and the AMZ 3e, so interference between signal light beams in the waveguide is avoided.

For example, the signal light beam S2c based on the local oscillator light beam having the specified center wavelength λc is input to the AMZ 3e, the monitor circuit Mon#5 monitors the power of the signal light beam S2c, and the control circuit Dec#3 controls each of the phase shifters Hu and Hd of the AMZ 3e. Thus, each of the phase shifters Hu and Hd of the AMZ 3e is controlled based on the power of the signal light beam S2c with a center wavelength λc, and thereby the signal light beam S1a in which crosstalk is reduced is output from the output coupler Cb of the AMZ 3e. That is, the relationship between the output port P#1 and the center wavelength Aa of the signal light beam S1a can be uniquely specified. As described above, the AMZ 3e has been described as an example, but the same applies to the AMZ 3a to 3d and 3f to 3i.

When the number of wavelengths of the optical transmission device TR2 is the same as that of the optical transmission device TR1, the device scale can be reduced, and for example, it is possible to contribute to power saving of a telecommunication company. On the other hand, if the power of the telecommunication company is the same as before, there is an advantage that the number of wavelengths can be increased without changing the device scale.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

For example, in the embodiment, the four LOs 5a, 5b, 5c, and 5d are used as single-wavelength light sources, but the number of single-wavelength light sources is not particularly limited, and may be, for example, eight or sixteen.

What is claimed is:

1. An optical transmission device comprising:
an optical circuit in which optical unit circuit groups are connected in multiple stages in a tree form, each of the optical unit circuit groups including three optical unit circuits of a two-input two-output type each having periodic transmission characteristics, the three optical unit circuits being connected in multiple stages in a tree form so that a first subsequent-stage port of two subsequent-stage ports of a first optical unit circuit, which is arranged at a preceding-stage as one of the three optical unit circuits, is connected to a first preceding-stage port of two preceding-stage ports of a second optical unit circuit, which is arranged at a subsequent-stage as one of the remaining two of the three optical unit circuits, and a second subsequent-stage port of the two subsequent-stage ports of the first optical unit circuit is connected to a first preceding-stage port of two preceding-stage ports of a third optical unit circuit, which is arranged at a subsequent-stage as the other of the remaining two of the three optical unit circuit;
a first light source that outputs a first local oscillator light beam;
a second light source that outputs a second local oscillator light beam having a frequency that is half a period away from a period of the second optical unit circuit;
an optical modulator including:
a predetermined output port that is connected to a first subsequent-stage port of two subsequent-stage ports provided in the second optical unit circuit at a last stage included in a first optical unit circuit group, which is arranged at a last stage of the optical circuit among the three optical unit circuit groups, and
a predetermined input port that is connected to the first light source;
a 90-degree hybrid circuit including:
a first input port connected to a second subsequent-stage port of the two subsequent-stage ports provided in the second optical unit circuit at the last stage, and
a second input port connected to the second light source,
wherein the optical circuit demultiplexes a first wavelength-multiplexed signal light beam input to a first preceding-stage port of two preceding-stage ports provided in the first optical unit circuit included in a second optical unit circuit group, which is arranged at a first stage of the optical circuit among the three optical unit circuit groups, into first signal light beams with respective first wavelengths different from each other and outputs the first signal light beams from the second subsequent-stage port of the two subsequent-stage ports provided in the second optical unit circuit at the last stage, and multiplexes second signal light beams with respective second wavelengths, which are not adjacent to the first wavelengths, input to the first subsequent-stage port of the two subsequent-stage ports provided in the second optical unit circuit at the last stage, and outputs a second wavelength-multiplexed signal light beam from a second preceding-stage port of the two preceding-stage ports provided in the first optical unit circuit at the first stage.

2. The optical transmission device according to claim 1, wherein each of the three optical unit circuits includes:
an asymmetric Mach-Zehnder interferometer having a pair of arms with different lengths, and
a phase shifter that adjusts an optical phase in the asymmetric Mach-Zehnder interferometer.

3. The optical transmission device according to claim 2, further comprising:
a monitor circuit that is provided at a position where the second signal light beams are received and monitors power of the second signal light beams; and
a first control circuit configured to control the phase shifter to decrease the power in accordance with a monitoring result of the power by the monitor circuit,
wherein the first control circuit is provided in the second optical unit circuit.

4. The optical transmission device according to claim 2, further comprising:
a monitor circuit that is provided at a position where the second signal light beams are received and monitors power of the second signal light beams; and
a second control circuit configured to control the phase shifter to increase the power in accordance with a monitoring result of the power by the monitor circuit,
wherein the second control circuit is provided in the first optical unit circuit.

5. The optical transmission device according to claim 1, wherein the first optical unit circuit, the second optical unit circuit, and the third optical unit circuit have the same period.
